(19) United States
(12) Patent Application Publication
(10) Pub. No.: US 2019/0117016 A1
(43) Pub. Date: Apr. 25, 2019

(54) Outdoor Cooking Assembly

(71) Applicants: Leopoldo Ramirez, Milton Center, OH (US); David Ramirez, Milton Center, OH (US)

(72) Inventors: Leopoldo Ramirez, Milton Center, OH (US); David Ramirez, Milton Center, OH (US)

(21) Appl. No.: 15/791,899

(22) Filed: Oct. 24, 2017

(51) Int. Cl. A47J 37/07

(52) U.S. Cl. CPC A47J 37/0704; A47J 37/0786

(57) ABSTRACT

An outdoor cooking assembly for that uses an open wood fire for cooking includes a fire unit that has wood positioned thereon for burning thereby generating heat for cooking. The fire unit is elevated above a support surface and the fire unit includes a circular plate. A cooking unit is coupled to the fire unit and the cooking unit is heated by the wood when the wood is burning on the fire unit. A food item is positioned on the cooking unit for cooking. The cooking unit includes a circular plate and the circular plate corresponding to the cooking unit is spaced from the circular plate corresponding to the fire unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to cooking devices and more particularly pertains to a new cooking device that uses an open wood fire for cooking.

### BRIEF SUMMARY OF THE INVENTION

An embodiment of the disclosure meets the needs presented above by generally comprising a fire unit that has wood positioned thereon for burning thereby generating heat for cooking. The fire unit is elevated above a support surface and the fire unit includes a circular plate. A cooking unit is coupled to the fire unit and the cooking unit is heated by the wood when the wood is burning on the fire unit. A food item is positioned on the cooking unit for cooking. The cooking unit includes a circular plate and the circular plate corresponding to the cooking unit is spaced from the circular plate corresponding to the fire unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an outdoor cooking assembly according to an embodiment of the disclosure.

FIG. 2 is a back perspective view of an embodiment of the disclosure.

FIG. 3 is a right side phantom view of an embodiment of the disclosure.

FIG. 4 is a back view of an embodiment of the disclosure.

FIG. 5 is a bottom view of an embodiment of the disclosure.

### DETAILED DESCRIPTION OF THE INVENTION

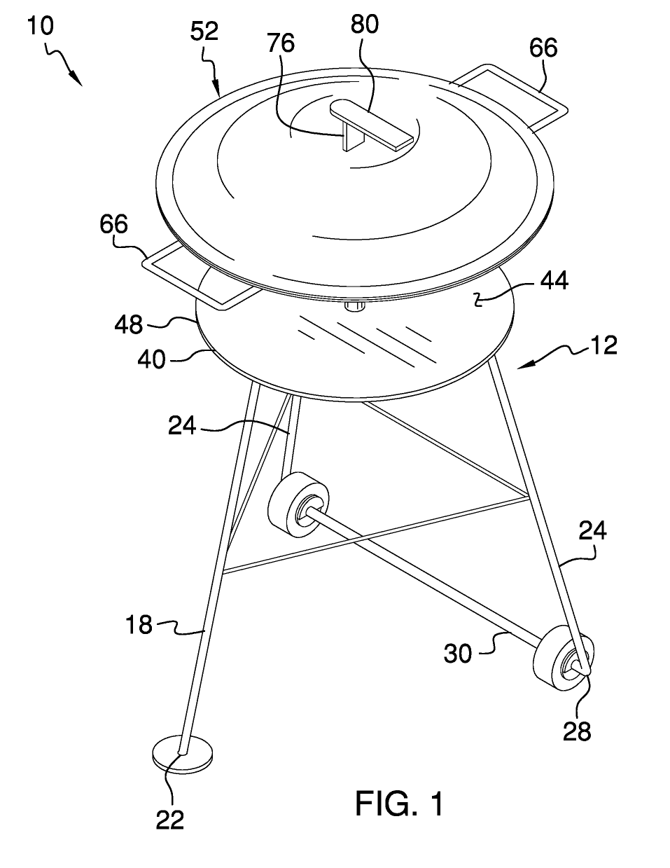

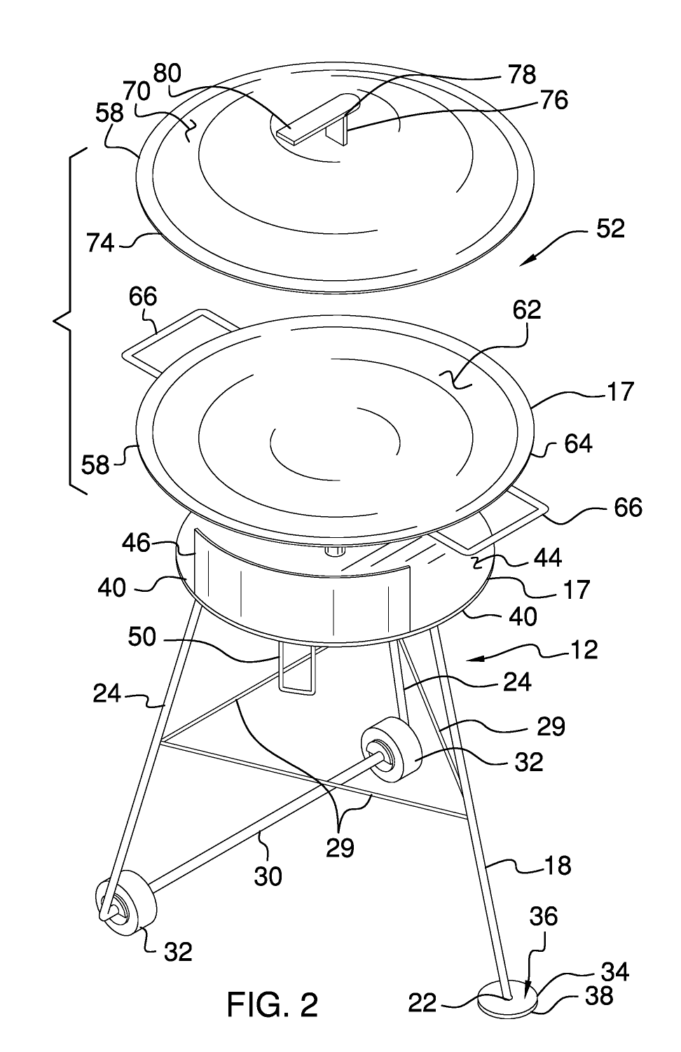

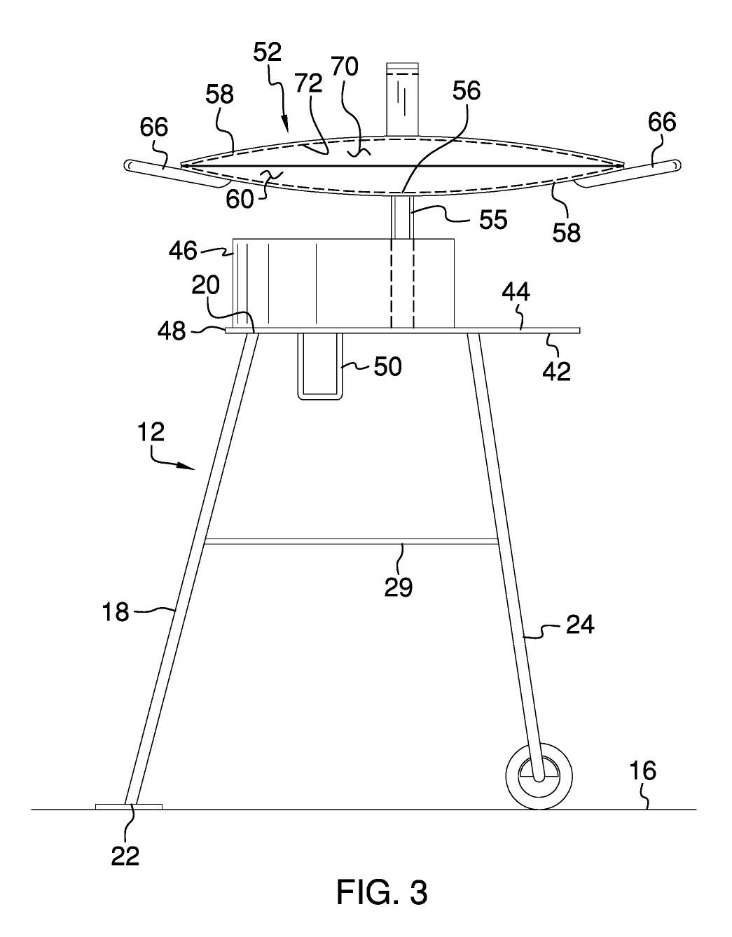

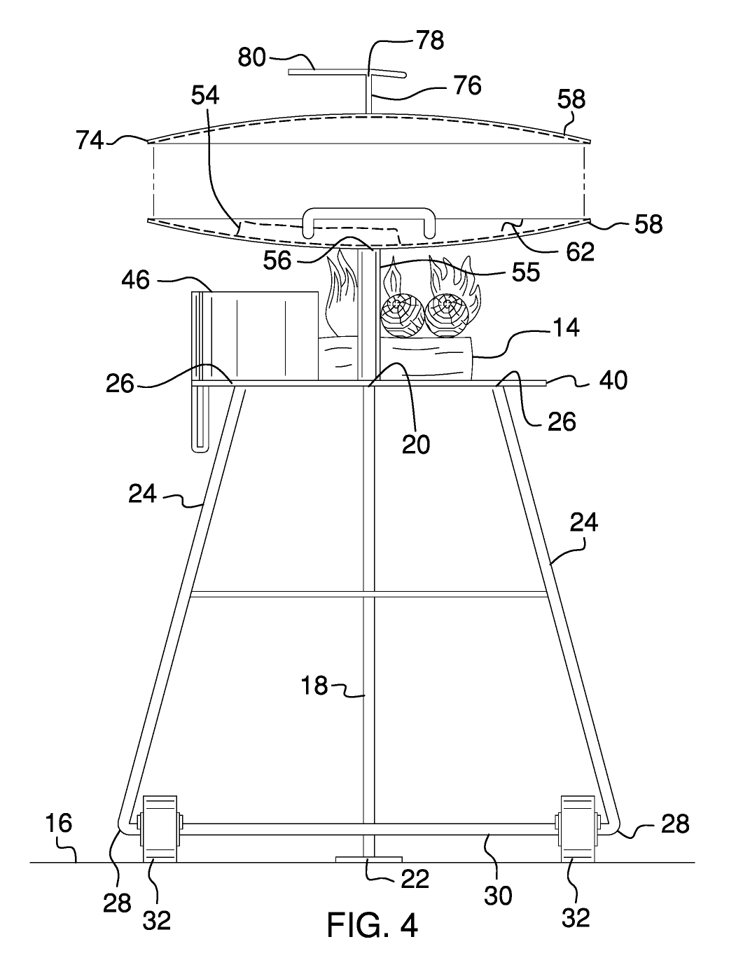

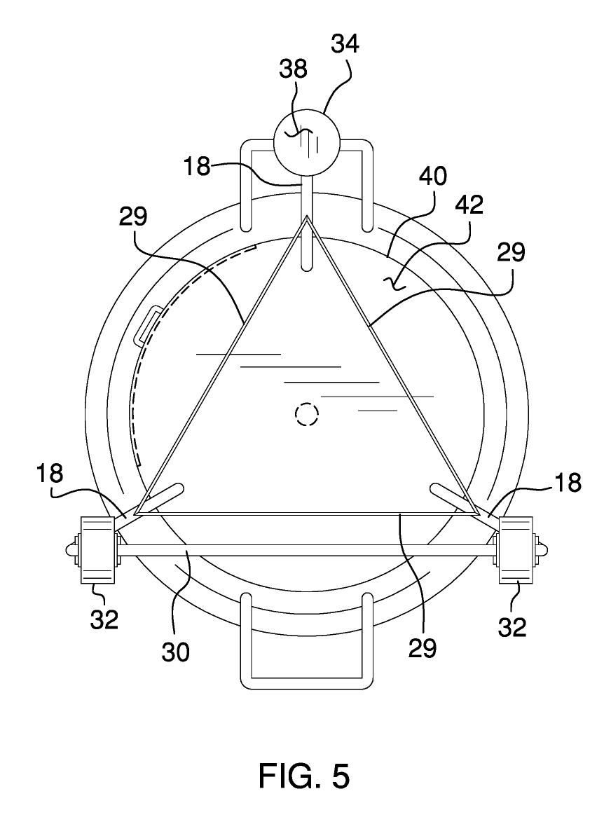

With reference now to the drawings, and in particular to FIGS. 1 through 5 thereof, a new cooking device embodying the principles and concepts of an embodiment of the disclosure and generally designated by the reference numeral 10 will be described.

As best illustrated in FIGS. 1 through 5, the outdoor cooking assembly 10 generally comprises a fire unit 12 that has wood 14 positioned thereon for burning thereby generating heat for cooking. The fire unit 12 is elevated above a support surface 16 such as ground or the like and the fire unit 12 includes a circular plate 17. Additionally, charcoal and any other flammable fuel source may be burned in the fire unit 12.

The fire unit 12 comprises a first leg 18 that has a first end 20 and a second end 22 and a pair of second legs 24 that each has a first end 26 and a second end 28. A plurality of braces 29 is coupled between the second legs 24 and the first leg 18 such that each of the second legs 24 and the first leg 18 is positioned to define an associated one of three corners of a triangle. An axle 30 extends between the second end 28 corresponding to each of the second legs 24. A pair of wheels 32 is each rotatably coupled to the axle 30 to roll along the support surface 16.

A plate 34 is provided that has a first surface 36 and a second surface 38. The first surface 36 is coupled to the second end 22 of the first leg 18 and the second surface 38 of the plate 34 abuts the support surface 16 when the wheels 32 are stationary on the support surface 16. A first disc 40 is provided that has a first surface 42 and a second surface 44. The first end 26 corresponding to each of the second legs 24 and the first leg 18 is coupled to the first surface 42 of the first disc 40. In this way the first disc 40 is spaced from the support surface 16. The wood 14 is positioned on the second disk for burning and the first disc 40 is comprised of a heat resistant material such as steel or the like.

A shield 46 is coupled to and extends upwardly from the second surface 44 of the first disc 40 to shield 46 the wood 14 from wind. The shield 46 is substantially coextensive with a perimeter edge 48 of the first disc 40. A hanger 50 is coupled to and extends downwardly from the first surface 42 of the first disc 40. The hanger 50 is aligned with the perimeter edge of the first disc 40. The hanger 50 may have a central member extending between a pair of end members in each of the end members may be coupled to the first disc 40.

A cooking unit 52 is coupled to the fire unit 12 and the cooking unit 52 is heated by the wood 14 when the wood 14 is burning on the fire unit 12. A food item 54, such as raw meat, vegetables and any other food item 54 commonly cooked is positioned on the cooking unit 52 for cooking. The cooking unit 52 includes a circular plate 17 and the circular plate 17 corresponding to the cooking unit 52 is spaced from the circular plate 17 corresponding to the fire unit 12.

The cooking unit 52 includes a post 55 that is coupled to and extends upwardly from the second surface of the plate 34. The post 55 has a distal end 56 with respect to the plate 34 and the post 55 is centrally positioned on the plate 34. A second disc 58 is provided that has a first surface 60, a second surface 62 and a perimeter edge 64 extending therebetween. The second disc 58 is concavely arcuate with respect to the perimeter edge 64 such that the second disc 58 forms a bowl.

The first surface 60 of the second disc 58 is coupled to the distal end 56 of the post 55 and the post 55 is centrally positioned on the second disc 58. The food item 54 is positioned on the second surface 62 of the second disk 58 for cooking. Additionally, the second disc 58 is comprised of a thermally conductive material such as steel or the like. Thus, the second disc 58 is in thermal communication with the wood 14 when the wood 14 is burning thereby facilitating the food item 54 to be cooked.

A pair of handles 66 is provided and each of the handles 66 is coupled to and extends laterally away from the perimeter edge 64 of the second disc 58 for gripping. Each of the handles 66 is positioned on opposite sides of the second disc 58 with respect to each other. Additionally, each of the handles 66 may include a central member extending between a pair of end members. Each of the end members corresponding to each of the handles 66 may be coupled to the second disc 58 in the central member of the handles 66 may be gripped.

A third disc 68 is provided that has a primary surface 70, a secondary surface 72 and a peripheral edge 74 extending therebetween. The third disc 68 is concavely arcuate with respect to the peripheral edge 74 such that the third disc 68 forms a bowl. The third disc 68 has a diameter that is equal to a diameter of the second disc 58. Additionally, the third disc 68 is selectively positioned on the plate 34 having the peripheral edge 74 of the third disc 68 being aligned with the perimeter edge of the second disc 58. Moreover, the third disc 68 is inversely arcuate with respect to the second disc 58 such that the third disc 68 and the second disc 58 form an enclosure when the third disc 68 is positioned on the second disc 58.

A first member 76 is coupled to and extends upwardly from the secondary surface 72 of the third disc 68. The first member 76 has a distal end 78 with respect to the secondary surface 72 and the first member 76 is centrally positioned on the third disc 68. A second member 80 is coupled to the distal end 78 of the first member 76 and the second member 80 is oriented perpendicular to the first member 76. The second member 80 is gripped for manipulating the third disc 68. Additionally, the second member 80 selectively engages the hanger 50 to suspend the third disc 68 on the hanger 50.

In use, the wood 14 is positioned on the first disc 40 and the wood 14 is burned to generate heat for cooking. The food item 54 is positioned on the second disc 58 thereby facilitating the heat from the burning wood 14 to cook the food item 54. The third disc 68 is selectively positioned on the second disc 58 to cover the food item 54 when the food item 54 is cooking. Additionally, the second member 80 is selectively positioned on the hanger 50 to suspend the third disc 68 from the hanger 50 during storage.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An outdoor cooking assembly being configured to burn wood to generate heat for cooking, said assembly comprising:
a fire unit being configured to have wood positioned thereon for burning thereby generating heat for cooking, said fire unit being configured to be elevated above a support surface, said fire unit including a circular plate; and
a cooking unit being coupled to said fire unit wherein said cooking unit is configured to be heated by the wood when the wood is burning on said fire unit, said cooking unit being configured to have a food item positioned thereon for cooking, said cooking unit including a circular plate, said circular plate corresponding to said cooking unit being spaced from said circular plate corresponding to said fire unit.

2. The assembly according to claim 1, wherein said fire unit comprises:
a first leg having a first end and a second end; and
a pair of second legs, each of said second legs having a first end and a second end.

3. The assembly according to claim 2, further comprising a plurality of braces, said plurality of braces being coupled between said second legs and said first leg such that each of said second legs and said first leg is positioned to define an associated one of three corners of a triangle.

4. The assembly according to claim 2, further comprising:
an axle extending between said second end corresponding to each of said second legs; and
a pair of wheels, each of said wheels being rotatably coupled to said axle wherein each of said wheels is configured to roll along the support surface.

5. The assembly according to claim 2, further comprising a plate having a first surface and a second surface, said first surface being coupled to said second end of said first leg wherein said second surface of said plate is configured to abut the support surface.

6. The assembly according to claim 2, further comprising a first disc having a first surface and a second surface, said first end corresponding to each of said second legs and said first leg being coupled to said first surface of said first disc wherein said first disc is configured to be spaced from the support surface, said second surface being configured to have the wood positioned thereon for burning, said first disc being comprised of a heat resistant material.

7. The assembly according to claim 6, further comprising a shield being coupled to and extending upwardly from said second surface of said first disc wherein said shield is configured to shield the wood from wind, said shield being substantially coextensive with a perimeter edge of said first disc.

8. The assembly according to claim 6, further comprising a hanger being coupled to and extending downwardly from said first surface of said first disc, said hanger being aligned with said perimeter edge of said first disc.

9. The assembly according to claim 5, further comprising said cooking unit comprises a post being coupled to and extending upwardly from said second surface of said plate, said post having a distal end with respect to said plate, said post being centrally positioned on said plate.

10. The assembly according to claim 9, further comprising a second disc having a first surface, a second surface and a perimeter edge extending therebetween, said second disc being concavely arcuate with respect to said perimeter edge such that said second disc forms a bowl, said first surface of said second disc being coupled to said distal end of said post having said post being centrally positioned on said second disc, said second surface of said second disc being configured to have the food item positioned thereon.

11. The assembly according to claim 10, wherein said second disc is comprised of a thermally conductive material wherein said second disc is configured to be in thermal communication with the wood when the wood is burning thereby facilitating the food item to be cooked.

12. The assembly according to claim 10, further comprising a pair of handles, each of said handles being coupled to and extending laterally away from said perimeter edge of said second disc wherein each of said handles is configured to be gripped, each of said handles being positioned on opposite sides of said second disc with respect to each other.

13. The assembly according to claim 10, further comprising a third disc having a primary surface, a secondary surface and a peripheral edge extending therebetween, said third disc being concavely arcuate with respect to said peripheral edge such that said the third disc forms a bowl, said third disc having a diameter being equal to a diameter of said second disc.

14. The assembly according to claim 13, wherein said third disc is selectively positioned on said plate having said peripheral edge of said third disc being aligned with said perimeter edge of said second disc, said third disc being inversely arcuate with respect to said second disc such that said third disc and said second disc forms an enclosure when said third disc is positioned on said second disc.

15. The assembly according to claim 14, further comprising a first member being coupled to and extending upwardly from said secondary surface of said third disc, said first member having a distal end with respect to said secondary surface, said first member being centrally positioned on said third disc.

16. The assembly according to claim 15, further comprising a second member being coupled to said distal end of said third member having said second member being oriented perpendicular to said first member wherein said second member is configured to be gripped for manipulating said third disc, said second member selectively engaging said hanger to suspend said third disc on said hanger.

17. An outdoor cooking assembly being configured to burn wood to generate heat for cooking, said assembly comprising:
a fire unit being configured to have wood positioned thereon for burning thereby generating heat for cooking, said fire unit being configured to be elevated above a support surface, said fire unit including a circular plate, said fire unit comprising:
a first leg having a first end and a second end,
a pair of second legs, each of said second legs having a first end and a second end,
a plurality of braces, said plurality of braces being coupled between said second legs and said first leg such that each of said second legs and said first leg is positioned to define an associated one of three corners of a triangle,
an axle extending between said second end corresponding to each of said second legs,
a pair of wheels, each of said wheels being rotatably coupled to said axle wherein each of said wheels is configured to roll along the support surface,
a plate having a first surface and a second surface, said first surface being coupled to said second end of said first leg wherein said second surface of said plate is configured to abut the support surface,
a first disc having a first surface and a second surface, said first end corresponding to each of said second legs and said first leg being coupled to said first surface of said first disc wherein said first disc is configured to be spaced from the support surface, said second surface being configured to have the wood positioned thereon for burning, said first disc being comprised of a heat resistant material,
a shield being coupled to and extending upwardly from said second surface of said first disc wherein said shield is configured to shield the wood from wind, said shield being substantially coextensive with a perimeter edge of said first disc, and
a hanger being coupled to and extending downwardly from said first surface of said first disc, said hanger being aligned with said perimeter edge of said first disc; and
a cooking unit being coupled to said fire unit wherein said cooking unit is configured to be heated by the wood when the wood is burning on said fire unit, said cooking unit being configured to have a food item positioned thereon for cooking, said cooking unit including a circular plate, said circular plate corresponding to said cooking unit being spaced from said circular plate corresponding to said fire unit, said cooking unit comprising:
a post being coupled to and extending upwardly from said second surface of said plate, said post having a distal end with respect to said plate, said post being centrally positioned on said plate,
a second disc having a first surface, a second surface and a perimeter edge extending therebetween, said second disc being concavely arcuate with respect to said perimeter edge such that said second disc forms a bowl, said first surface of said second disc being coupled to said distal end of said post having said post being centrally positioned on said second disc, said second surface of said second disc being configured to have the food item positioned thereon, said second disc being comprised of a thermally conductive material wherein said second disc is configured to be in thermal communication with the wood when the wood is burning thereby facilitating the food item to be cooked,
a pair of handles, each of said handles being coupled to and extending laterally away from said perimeter edge of said second disc wherein each of said handles is configured to be gripped, each of said handles being positioned on opposite sides of said second disc with respect to each other,
a third disc having a primary surface, a secondary surface and a peripheral edge extending therebetween, said third disc being concavely arcuate with respect to said peripheral edge such that said the third disc forms a bowl, said third disc having a diameter being equal to a diameter of said second disc, said third disc being selectively positioned on said plate having said peripheral edge of said third disc being aligned with said perimeter edge of said second disc, said third disc being inversely arcuate with respect to said second disc such that said third disc and said second disc forms an enclosure when said third disc is positioned on said second disc,
a first member being coupled to and extending upwardly from said secondary surface of said third disc, said first member having a distal end with respect to said secondary surface, said first member being centrally positioned on said third disc, and
a second member being coupled to said distal end of said third member having said second member being oriented perpendicular to said first member wherein said second member is configured to be gripped for manipulating said third disc, said second member selectively engaging said hanger to suspend said third disc on said hanger.
